(19) United States
(12) Patent Application Publication
(10) Pub. No.: US 2020/0341560 A1
(43) Pub. Date: Oct. 29, 2020

(54) METHOD AND DEVICE FOR SWITCHING DIRECTION SETTING OF DIRECTION KEYS

(71) Applicant: Delta Electronics, Inc., Taoyuan City (TW)

(72) Inventor: Tung-Chin WU, Taoyuan City (TW)

(21) Appl. No.: 16/597,038

(22) Filed: Oct. 9, 2019

(30) Foreign Application Priority Data
Apr. 26, 2019 (CN) 201910344654.9

(51) Int. Cl. G06F 3/023; G06F 3/0346

(52) U.S. Cl. CPC G06F 3/0238; G06F 3/0346

(57) ABSTRACT

A method for switching a direction setting of direction keys is provided. The method is applied to a device and includes: receiving a signal, wherein the device is defined as having a first axis and a second axis, and the signal indicates a first-axis rotation angle of the device around the first axis and a second-axis rotation angle of the device around the second axis; and switching the direction setting of the direction keys in a key area of the device according to the first-axis rotation angle and the second-axis rotation angle to perform directional control on a current display image displayed by the device.

### CROSS REFERENCE TO RELATED APPLICATIONS

This application claims priority to Chinese Patent Application No. 201910344654.9 filed on Apr. 26, 2019 in the China Intellectual Property Office, the contents of which are incorporated by reference herein.

### TECHNICAL FIELD

The disclosure relates to a method and a device for setting directions, and more particularly, it relates to a method and a device for switching a direction setting of direction keys.

### BACKGROUND

Projectors are used in various locations, such as at companies, at event sites, in schools, and in homes. A projector used in these places can be placed on a desk or the like and project onto a screen (hereinafter referred to as normal position), or suspended from a high position such as a ceiling and fixed thereto using a fixing jig, with the position of the projector set upside down for projection (hereinafter referred to as suspended position).

FIG. 1A illustrates a rear view in which the projector 100 is placed in a normal position. As shown in FIG. 1A, the key area 110 is fixed to the rear of the projector 100, and the right side of FIG. 1A shows an enlarged view of the key area 110 including an “up” key 112, a “down” key 116, a “left” key 114, and a “right” key 118. When the projector 100 projects images in the normal position, the user can intuitively control the projection screen or the On-Screen Display (OSD) menu according to the directions of the direction keys.

FIG. 1B shows a rear view in which the projector 100 is rotated 90 degrees counterclockwise. As shown in FIG. 1B, when the projector 100 projects images at this position, the user cannot intuitively control the projection screen or the OSD menu according to the directions of the direction keys. For example, when the user wants to control the projection screen to move to the right, the user does not press the right key 116, but must press the “right” key 118 in the upward direction to adjust the screen.

FIG. 1C shows a rear view of the projector 100 placed in a suspended position. As shown in FIG. 1C, when the projector 100 projects images at the suspended position, the user cannot intuitively control the projection screen or the OSD menu according to the directions of the direction keys. For example, when the user wants to control the projection screen to move to the right, the user does not press the right key 114, but must press the “right” key 118 in the left direction to adjust the screen.

As described above, when the projector projects images at different positions, the user cannot intuitively control the projection screen or the OSD menu according to the directions of the direction keys. This will give the user a bad user experience.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and a device for switching a direction setting of direction keys to improve the disadvantages.

In a preferred embodiment, a method for switching a direction setting of direction keys, applied to a device, comprising: receiving a signal, wherein the device is defined as having a first axis and a second axis, and the signal indicates a first-axis rotation angle of the device around the first axis and a second-axis rotation angle of the device around the second axis; and switching the direction setting of the direction keys in a key area of the device according to the first-axis rotation angle and the second-axis rotation angle to perform directional control on a current display image displayed by the device.

In some embodiments, the direction keys have a first direction setting, and the step of switching the direction setting of the direction keys in a key area of the device according to the first-axis rotation angle and the second-axis rotation angle further comprises: obtaining rotation information of the direction keys according to the first-axis rotation angle and the second-axis rotation angle; determining whether the rotation information is the same as the first direction setting; and setting the first direction setting to a second direction setting according to the rotation information when the rotation information is different from the first direction setting, and controlling the direction of the current display image according to the second direction setting.

In some embodiments, the rotation information of the direction keys is obtained from a lookup table.

In some embodiments, the method further comprises: storing the direction settings; newly receiving the signal for a predetermined period of time, and determining whether the first-axis rotation angle and the second-axis rotation angle are changed; and switching the direction setting of the direction keys and storing the direction setting when the first-axis rotation angle and the second-axis rotation angle are changed.

In some embodiments, the signal is generated by a motion sensor, wherein the motion sensor is a gyroscope, an accelerometer or a gravity sensor (G-sensor).

In some embodiments, the signal is manually input by a user.

In some embodiments, the device is a projector.

In some embodiments, the current display image is an image projected by the projector.

In some embodiments, the device is a liquid-crystal display.

In a preferred embodiment, a device for switching a direction setting of direction keys is provided. The device comprises one or more processors and one or more computer storage media for storing one or more computer-readable instructions. The processor is configured to drive the computer storage media to execute the following tasks: receiving a signal, wherein the device is defined as having a first axis and a second axis, and the signal indicates a first-axis rotation angle of the device around the first axis and a second-axis rotation angle of the device around the second axis; and switching the direction setting of the direction keys in a key area of the device according to the first-axis rotation angle and the second-axis rotation angle to perform directional control on a current display image displayed by the device.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1A illustrates a rear view in which the projector is placed in a normal position.

FIG. 1B shows a rear view in which the projector is rotated 90 degrees counterclockwise.

FIG. 1C shows a rear view of the projector placed in a suspended position.

FIGS. 2A-2C show schematic diagrams showing a projector according to one embodiment of the present disclosure.

FIG. 3A is a schematic diagram illustrating the X-axis rotation of the projector according to an embodiment of the present disclosure.

FIG. 3B is a schematic diagram illustrating the Y-axis rotation of the projector according to an embodiment of the present disclosure.

FIG. 4 is a schematic diagram illustrating a liquid-crystal display according to an embodiment of the present disclosure.

FIG. 5 is a schematic diagram illustrating the X-axis rotation of the liquid-crystal display according to an embodiment of the present disclosure.

FIG. 6 is a flowchart illustrating a method of switching a direction setting of direction keys according to an embodiment of the present disclosure.

FIG. 7 is a flowchart illustrating a method for switching a direction setting of direction keys according to an embodiment of the present disclosure.

FIG. 8 is a schematic diagram illustrating a lookup table according to an embodiment of the present disclosure.

FIG. 9 is a schematic diagram illustrating a lookup table according to an embodiment of the present disclosure.

FIG. 10 is a schematic diagram illustrating a lookup table according to an embodiment of the present disclosure.

FIG. 11 is a schematic diagram illustrating a lookup table according to an embodiment of the present disclosure.

FIG. 12 illustrates an exemplary operating environment for implementing embodiments of the present disclosure.

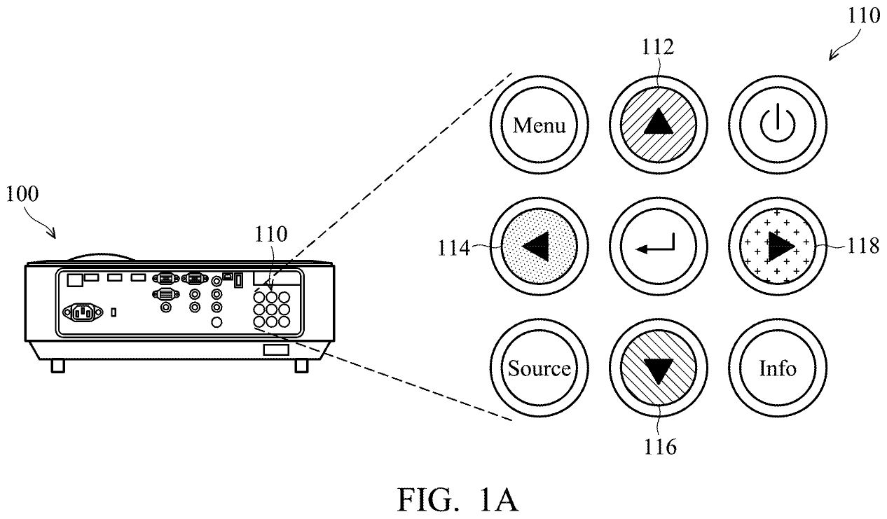

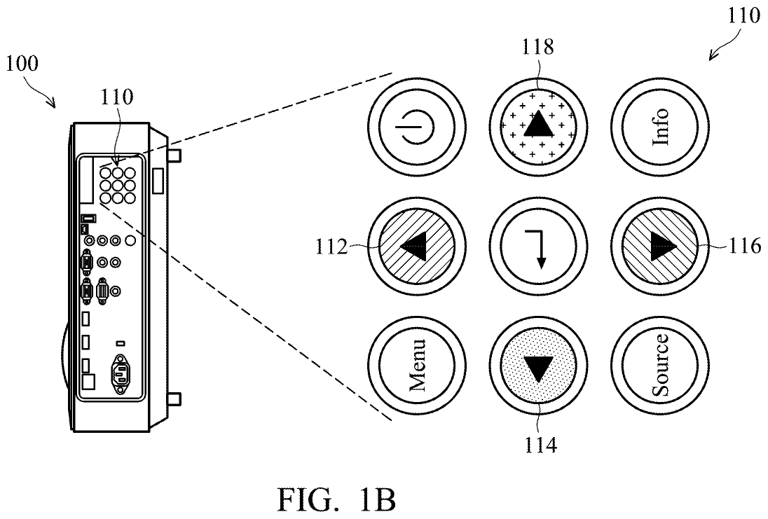

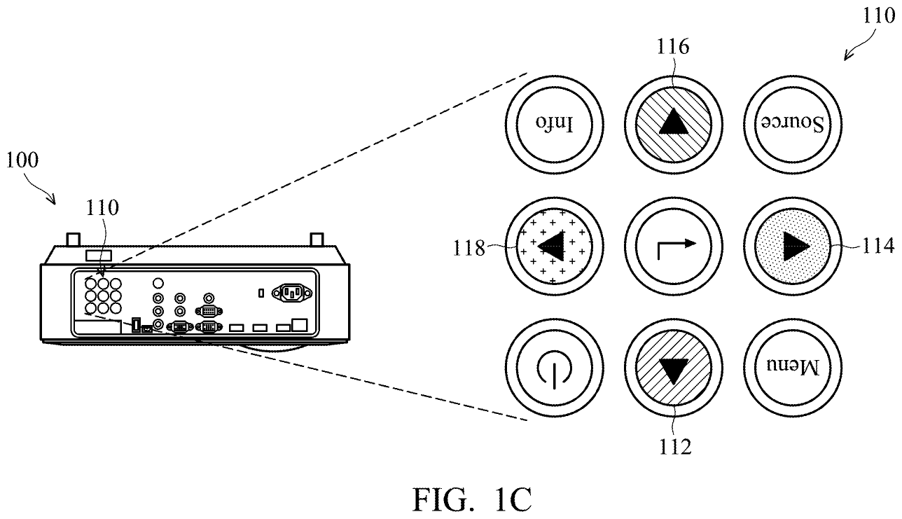

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

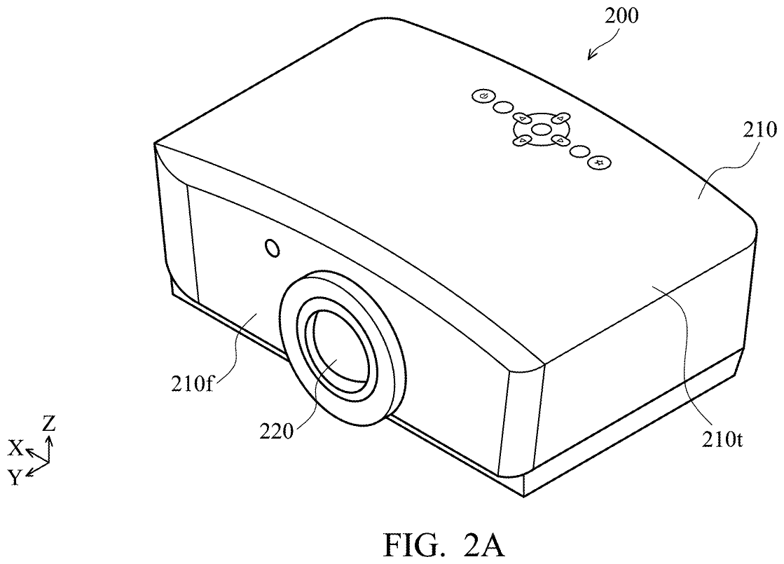

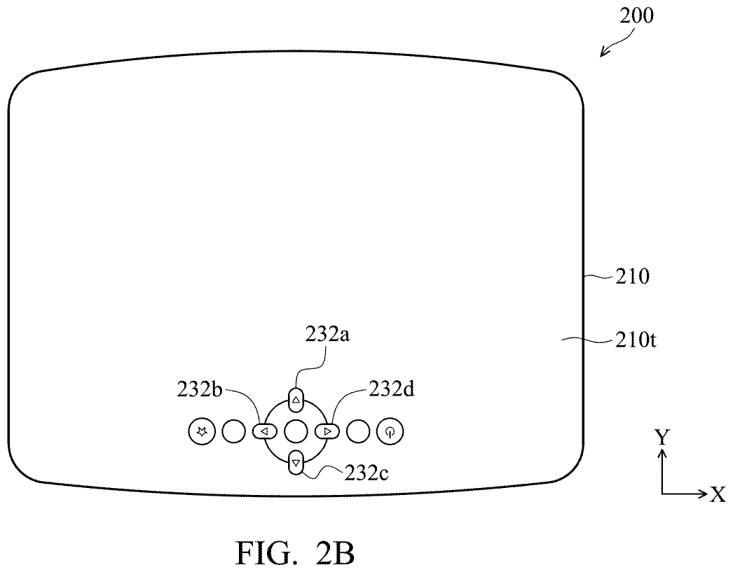

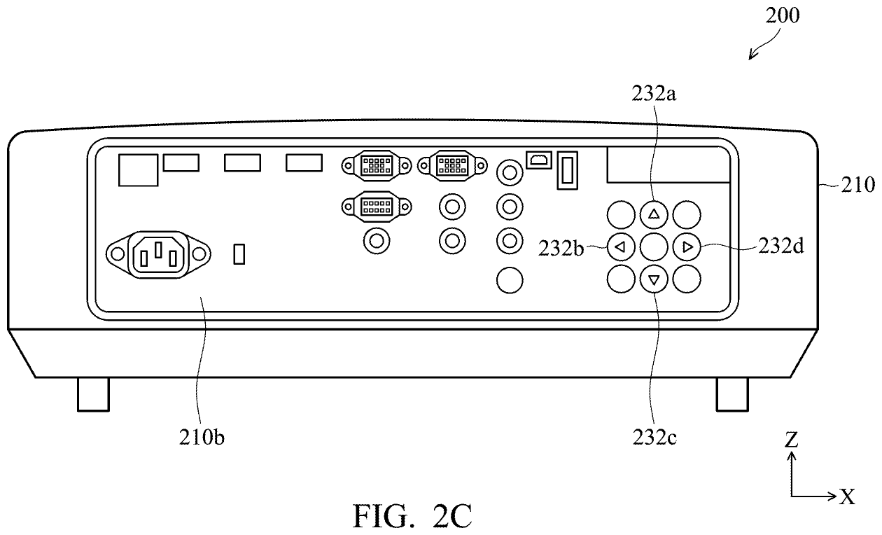

FIGS. 2A˜2C show schematic diagrams showing a projector 200 according to one embodiment of the present disclosure. FIG. 2A is a perspective diagram showing the projector 200. FIG. 2B is a schematic diagram showing the upper surface 210t of the projector 200. FIG. 2C shows a schematic diagram of the rear 210b of the projector 200. As shown in FIGS. 2A-2B, the main body of the projector 200 has a housing 210 in which the main body of the projector 200 is accommodated. As shown in FIG. 2A, a projection lens 220 is exposed through a front surface 210f of the housing 210 to project an image onto an external screen or the like. In one embodiment, the projector 200 may contain a lens shift mechanism (not shown in FIGS. 2A˜2C) which shifts the projection lens 220 to control the projection position of the image. In addition, as shown in FIGS. 2B and 2C, the upper surface 210t and the rear 210b of the housing 210 may be configured with I/O components, wherein the I/O components may include the direction keys 232a, 232b, 232c, 232d and other keys to receive input from the user. The user can preset which direction keys (the direction keys located on the upper surface 210t or the direction keys located at the rear 210b) the user wants to use.

The projector 200 may be equipped with a motion sensor for detecting motion (not shown in FIGS. 2A to 2C) to determine the rotation angle of the projector 200. The motion sensor can be a gravity sensor (G-sensor), an accelerometer, a gyroscope and so on. For convenience in explaining embodiments of the invention, an X-axis, a Y-axis and a Z-axis of the projector 200 are defined first. As shown in FIGS. 2A to 2C, the X-axis is perpendicular to the projection direction of the projector 200. The Y-axis is parallel to the projection direction of the projector 200. The Z-axis is perpendicular to the upper surface 210t of the projector 200. It should be noted that the disclosure is not limited to the X-axis, the Y-axis and the Z-axis described above. A skilled person in the art can make any modification and amendments according to embodiments of the disclosure.

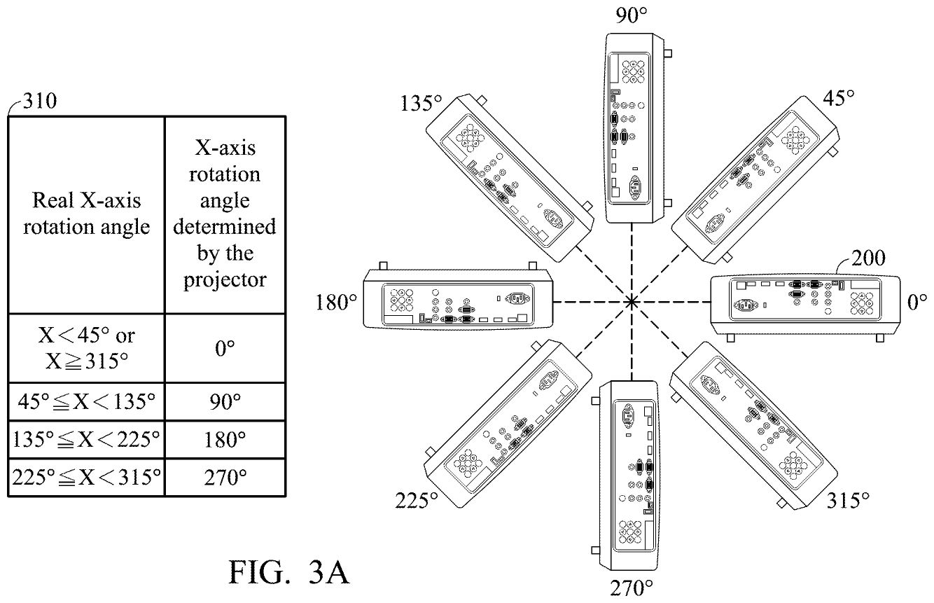

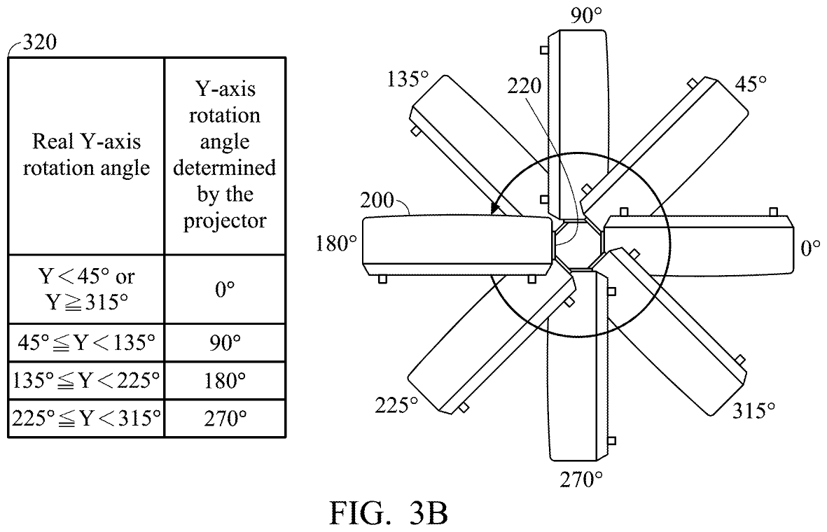

Next, the X-axis and Y-axis rotation angles are defined. FIG. 3A is a schematic diagram illustrating the X-axis rotation of the projector 200 according to an embodiment of the present disclosure. The projector 200 on the right side in FIG. 3A is a rear view of the projector 200. As shown in the rear view of the projector 200, the X-axis rotation angle of the projector 200 placed at the normal position is 0 degrees, wherein the X-axis rotation angle is increased by counterclockwise rotation. The table on the left side of FIG. 3A is a lookup table 310 recoding the X-axis rotation angles of the projector 200, and the lookup table 310 is stored in advance in the projector 200. As shown in the lookup table 310, when the real X-axis rotation angle is less than 45 degrees or greater than or equal to 315 degrees, the projector 200 determines that the X-axis rotation angle is 0 degrees. When the real X-axis rotation angle is greater than or equal to 45 degrees and less than 135 degrees, the projector 200 determines that the X-axis rotation angle is 90 degrees. When the real X-axis rotation angle is greater than or equal to 135 degrees and less than 225 degrees, the projector 200 determines that the X-axis rotation angle is 180 degrees. When the real X-axis rotation angle is greater than or equal to 225 degrees and less than 315 degrees, the projector 200 determines that the X-axis rotation angle is 270 degrees. Moreover, the lookup table 310 can be in any form of data/memory structure and/or implemented in a hardware/software form.

FIG. 3B is a schematic diagram illustrating the Y-axis rotation of the projector 200 according to an embodiment of the present disclosure. The projector 200 on the right side in FIG. 3A is a right side view of the projector 200. As shown in the right side view of the projector 200, the Y-axis rotation angle of the projector 200 placed at the normal position is 0 degrees, wherein the projection direction of the projection lens 220 is the same as the direction in which the Y-axis rotation angle is 0 degrees, and the Y-axis rotation angle is increased by counterclockwise rotation. The table on the left side of FIG. 3B is a lookup table 320 recoding the Y-axis rotation angles of the projector 200, and the lookup table 320 is stored in advance in the projector 200. As shown in the lookup table 320, when the real Y-axis rotation angle is less than 45 degrees or greater than or equal to 315 degrees, the projector 200 determines that the Y-axis rotation angle is 0 degrees. When the real Y-axis rotation angle is greater than or equal to 45 degrees and less than 135 degrees, the projector 200 determines that the Y-axis rotation angle is 90 degrees. When the real Y-axis rotation angle is greater than or equal to 135 degrees and less than 225 degrees, the projector 200 determines that the Y-axis rotation angle is 180 degrees. When the real Y-axis rotation angle is greater than or equal to 225 degrees and less than 315 degrees, the projector 200 determines that the Y-axis rotation angle is 270 degrees. Moreover, the lookup table 310 can be in any form of data/memory structure and/or implemented in a hardware/software form.

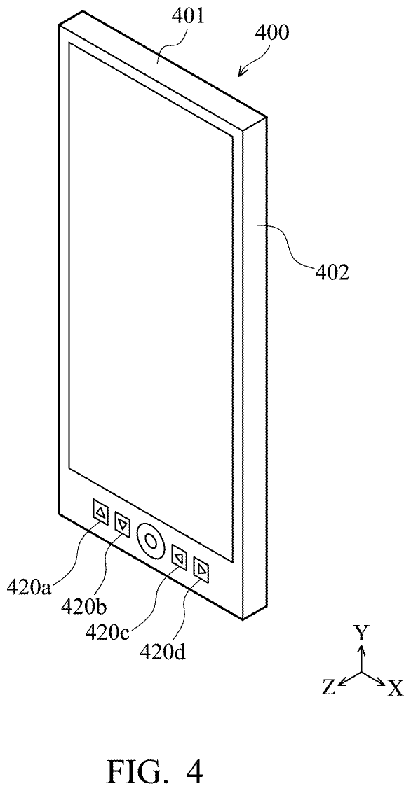

FIG. 4 is a schematic diagram illustrating a liquid-crystal display 400 according to an embodiment of the present disclosure. As shown in FIG. 4, the liquid-crystal display 400 comprises at least a display screen 410 and direction keys 420a, 420b, 420c and 420d disposed under the display screen. In an embodiment, the liquid-crystal display 400 may also be equipped with a motion sensor (not shown in FIG. 4) for detecting motion to determine the rotation angle of the liquid-crystal display 400. The motion sensor may be a gravity sensor (G-sensor), an accelerometer, a gyroscope, and so on.

The liquid-crystal display 400 is a rectangle having a short side 401 and a long side 402. For example, if the resolution of the liquid-crystal display 400 is 1920×1080, the length of the short side 401 is 1080 pixels, and the length of the long side 402 is 1920 pixels. When the liquid-crystal display 400 is placed in a portrait mode, as shown in FIG. 4, the short side 401 is at the upper side of the liquid-crystal display 400, and the long side 402 is at the left side of the liquid-crystal display 400. For convenience in explaining embodiments of the invention, an X-axis, a Y-axis and a Z-axis of the liquid-crystal display 400 are defined first. As shown in FIG. 4, the X-axis is parallel to the short side 401. The Y-axis is parallel to the long side 402. The Z-axis is perpendicular to the display screen of the liquid-crystal display 400. It should be noted that the disclosure is not limited to the X-axis, the Y-axis and the Z-axis described above. A skilled person in the art can make any modification and amendments according to embodiments of the disclosure.

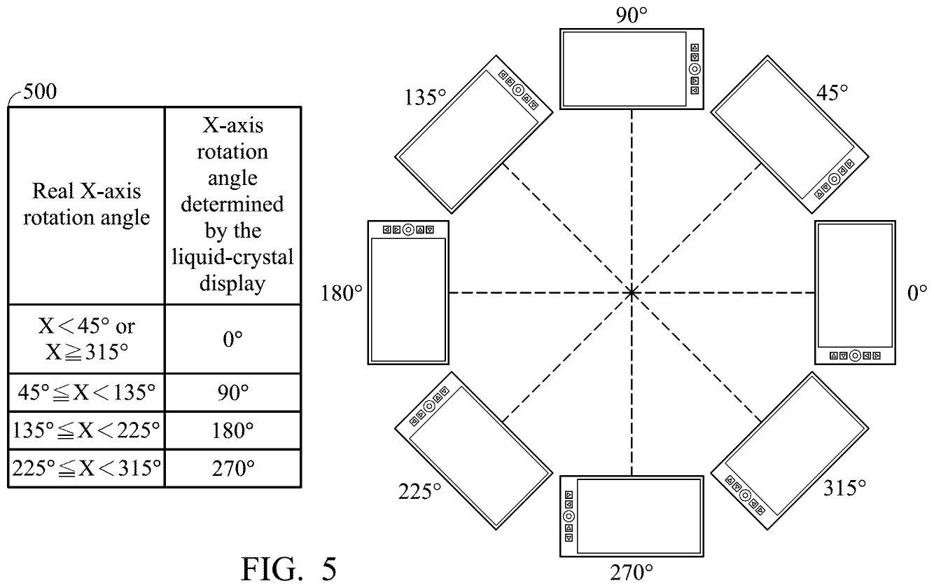

In general, the liquid-crystal display 400 only involves the X-axis rotation, and does not involve the Y-axis rotation as the projector 200 does. Therefore, the rotation angle of the liquid-crystal display 400 can be determined only by obtaining the X-axis information of the liquid-crystal display 400. Next, the X-axis rotation angle is defined. FIG. 5 is a schematic diagram illustrating the X-axis rotation of the liquid-crystal display 400 according to an embodiment of the present disclosure. As shown in the right figure of FIG. 5, the X-axis rotation angle of the liquid-crystal display 400 placed at the normal position is 0 degrees, and the X-axis rotation angle is increased by counterclockwise rotation. The table on the left side of FIG. 5 is a lookup table 500 recoding the X-axis rotation angles of the liquid-crystal display 400, and the lookup table 500 is stored in advance in the liquid-crystal display 400. As shown in the lookup table 500, when the real X-axis rotation angle is less than 45 degrees or greater than or equal to 315 degrees, the projector 200 determines that the X-axis rotation angle is 0 degrees. When the real X-axis rotation angle is greater than or equal to 45 degrees and less than 135 degrees, the liquid-crystal display 400 determines that the X-axis rotation angle is 90 degrees. When the real X-axis rotation angle is greater than or equal to 135 degrees and less than 225 degrees, the liquid-crystal display 400 determines that the X-axis rotation angle is 180 degrees. When the real X-axis rotation angle is greater than or equal to 225 degrees and less than 315 degrees, the liquid-crystal display 400 determines that the X-axis rotation angle is 270 degrees. Moreover, the lookup table 500 can be in any form of data/memory structure and/or implemented in a hardware/software form.

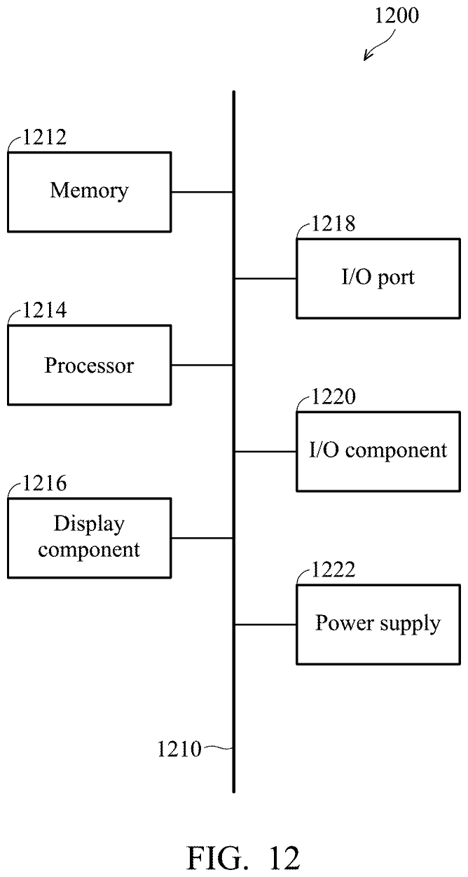

It should be noted that although the projector 200 shown in FIG. 2 and the liquid-crystal display 400 shown in FIG. 4 are used as examples in the disclosure, it should not be limited in the disclosure. In addition, each of the components shown in FIG. 2 and FIG. 4 may be implemented via any type of electronic device, such as the electronic device 1200 described with reference to FIG. 12, for example.

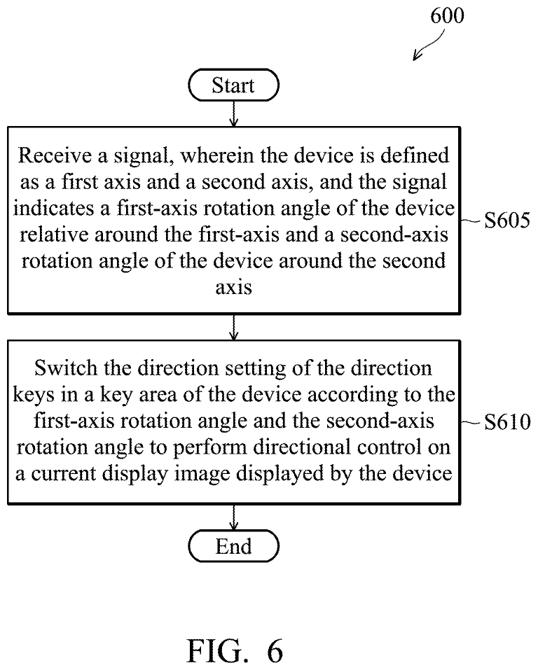

FIG. 6 is a flowchart illustrating a method 600 of switching a direction setting of direction keys according to an embodiment of the present disclosure. This method can be applied to a device, for example, the projector 200 shown in FIG. 2 and the liquid-crystal display 400 in FIG. 4. In addition, the direction keys of the device have a first direction setting. In an embodiment, the first direction setting may be a real direction setting, that is, the direction of the up key is “↑”, the direction of the down key is “↓”, the direction of the right key is “→”, and the direction of the left key is “←”.

In step S605, the device receives a signal, wherein the device is defined as a first axis and a second axis, and the signal indicates a first-axis rotation angle of the device relative around the first-axis and a second-axis rotation angle of the device around the second axis. In one embodiment, the signal is generated by a motion sensor that senses the device, wherein the motion sensor is a gyroscope, an accelerometer, or a gravity sensor (G-sensor). In another embodiment, the signal can be manually input by a user. For example, the user manually inputs the first-axis rotation angle and the second-axis rotation angle.

In step S610, the device switches the direction setting of the direction keys in a key area of the device according to the first-axis rotation angle and the second-axis rotation angle to perform directional control on a current display image displayed by the device. In one embodiment, when the device is a projector, the current display image is an image projected by the projector. When the device is a liquid-crystal display, the current display screen is a display screen of the liquid-crystal display.

In another embodiment, the device may store the direction setting after the device switches the direction settings of the direction keys. The device may newly receive the signal for a predetermined period of time (for example, 3 seconds) and determine whether the first-axis rotation angle and the second-axis rotation angle change. When the first-axis rotation angle and the second-axis rotation angle are changed, the device switches the direction setting of the direction keys again and stores the switched direction setting.

How the device switches the direction setting of the direction keys in a key area of the device according to the first-axis rotation angle and the second-axis rotation angle in step S610 will be described in detail below.

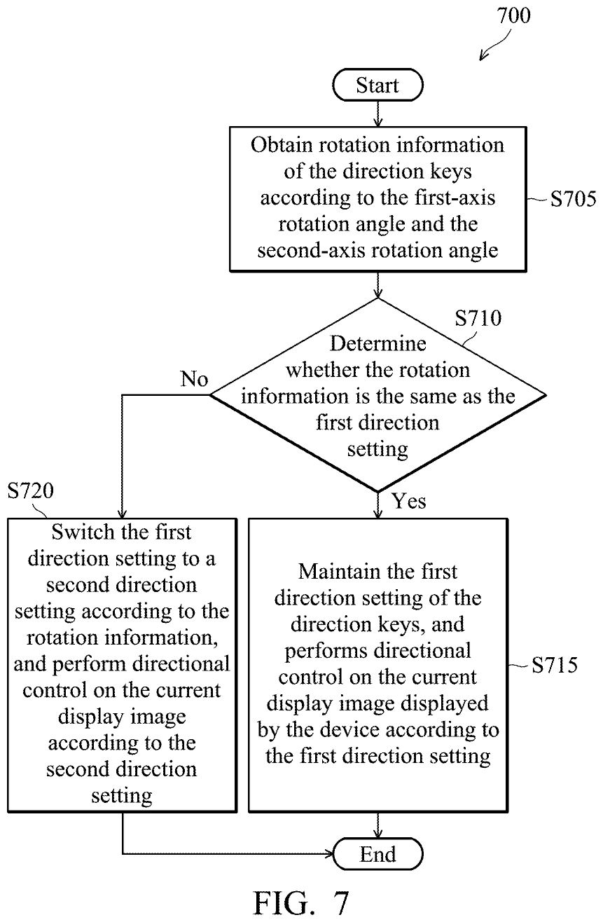

FIG. 7 is a flowchart illustrating a method 700 for switching a direction setting of direction keys according to an embodiment of the present disclosure. In step S705, the device obtains rotation information of the direction keys according to the first-axis rotation angle and the second-axis rotation angle. Next, in step S710, the device determines whether the rotation information is the same as the first direction setting. When the device determines that the rotation information is the same as the first direction setting (“Yes” in step S710), in step S715, the device maintains the first direction setting of the direction keys, and performs directional control on the current display image displayed by the device according to the first direction setting. When the device determines that the rotation information is different from the first direction setting (“No” in step S710), in step S720, the device switches the first direction setting to a second direction setting according to the rotation information, and performs directional control on the current display image according to the second direction setting. For example, when the rotation information of the direction keys are the direction of the up key indicating the left direction, the direction of the right key indicating the up direction, the direction of the down key indicating the right direction and the direction of the left key indicating the down direction, the projector switches the up key to the left key corresponding to the left direction, the right key to the up key corresponding to the up direction, the right key to the up key corresponding to the up direction and the left key to the down key corresponding to the down direction.

In an embodiment, when the device obtains the first-axis rotation angle and the second-axis rotation angle, the electronic device may obtain the rotation information of the direction keys by using a lookup table. The lookup table can be in any form of data/memory structure and/or implemented in a hardware/software form. In order to facilitate the description of the embodiments of the present disclosure, a projector will be generally described as a preferred embodiment.

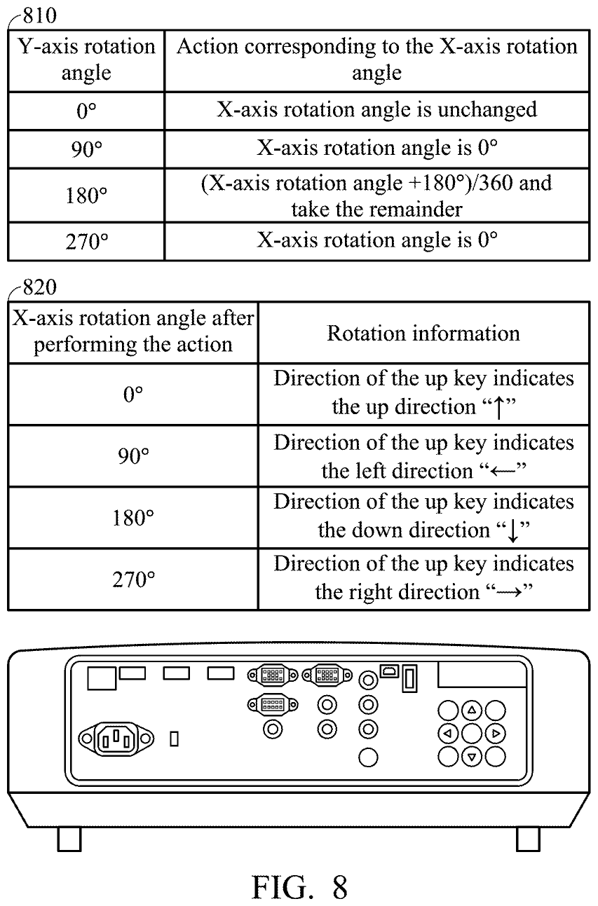

FIG. 8 is a schematic diagram illustrating a lookup table according to an embodiment of the present disclosure. In this embodiment, the lookup tables 810 and 820 can be stored in the memory of the projector. In this embodiment, the first axis of the projector is the X-axis and the second axis of the projector is the Y-axis, and the user uses the direction keys at the rear of the projector. The lookup tables 810 and 820 include lists of rotation information with the Y-axis rotation angles and the X-axis rotation angles as indices. It is assumed that the X-axis rotation angle and the Y-axis rotation angle determined by the projector are 180 degrees and 270 degrees, respectively. According to the lookup table 810, when the Y-axis rotation angle is 270 degrees, the action corresponding to the X-axis rotation angle indicates that the X-axis rotation angle is 0 degrees. Next, according to the lookup table 820, when the X-axis rotation angle is 0 degrees after performing the action, the rotation information of the direction keys indicates that the direction of the up key indicates the up direction, which is the same as the real direction setting. It should be noted that although the lookup table 820 only shows the direction of the up key, those skilled in the art can derive the rotation information of other direction keys. For example, when the X-axis rotation angle is 90 degrees after performing the action, the rotation information of the direction keys indicates that the direction of the right key indicates the up direction, the direction of the down key indicates the right direction, the direction of the left key indicates the down direction, and so on.

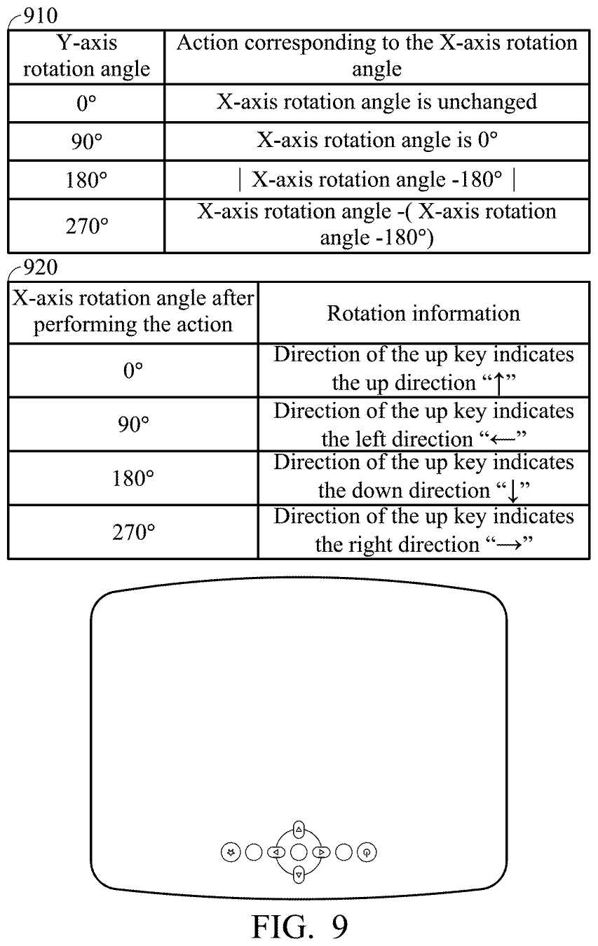

In another example, FIG. 9 is a schematic diagram illustrating a lookup table according to an embodiment of the present disclosure. In this embodiment, the lookup tables 910 and 920 can be stored in the memory of the projector. In this embodiment, the first axis of the projector is the X-axis and the second axis is the Y-axis, and the user uses the directional keys located on the upper surface of the projector. The lookup tables 910 and 920 include lists of rotation information with the Y-axis rotation angles and the X-axis rotation angles as indices. It is assumed that the X-axis rotation angle and the Y-axis rotation angle determined by the projector are 90 degrees and 180 degrees, respectively. According to the lookup table 910, when the Y-axis rotation angle is 180 degrees, the action corresponding to the X-axis rotation angle indicates that the X-axis rotation angle minus 180 degrees and then an absolute value is taken. Therefore, the result obtained by taking the absolute value of the X-axis rotation angle is 90 degrees after the X-axis rotation angle, 90 degrees, minus 180 degrees. Next, according to the lookup table 920, when the X-axis rotation angle after the performing the action is 90 degrees, the rotation information of the direction keys indicates that the up key indicates the left direction. It should be noted that although the lookup table 920 only shows the direction of the up key, those skilled in the art can derive the rotation information of other direction keys. For example, when the X-axis rotation angle is 90 degrees after performing the action, the rotation information of the direction keys indicates that the direction of the right key indicates the up direction, the direction of the down key indicates the right direction, the direction of the left key indicates the down direction, and so on.

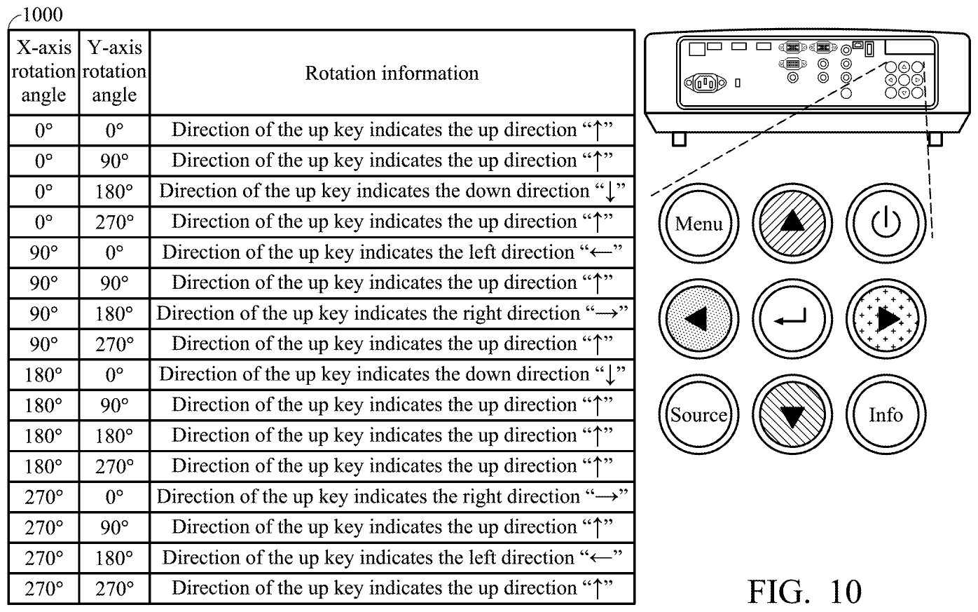

In addition, the lookup table can also have different forms. FIG. 10 is a schematic diagram illustrating a lookup table according to an embodiment of the present disclosure. In this embodiment, the lookup table 1000 can be stored in the memory of the projector. In this embodiment, the first axis of the projector is the X-axis and the second axis is the Y-axis, and the user uses the direction keys at the rear of the projector. The lookup table 1000 includes a list of rotation information with the Y-axis rotation angles and the X-axis rotation angles as indices. It is assumed that the X-axis rotation angle and the Y-axis rotation angle determined by the projector are 90 degrees and 0 degrees, respectively. According to the lookup table 1000, when the X-axis rotation angle is 90 degrees and the Y-axis rotation angle is 0 degrees, the rotation information of the direction keys indicates that the direction of the up key indicates the left direction. It should be noted that although the lookup table 1000 only shows the direction of the up key, those skilled in the art can derive the rotation information of other direction keys. For example, when the X-axis rotation angle is 90 degrees and the Y-axis rotation angle is 0 degrees, the rotation information of the direction keys indicates that the direction of the right key indicates the up direction, the direction of the down key indicates the right direction, the direction of the left key indicates the down direction, and so on.

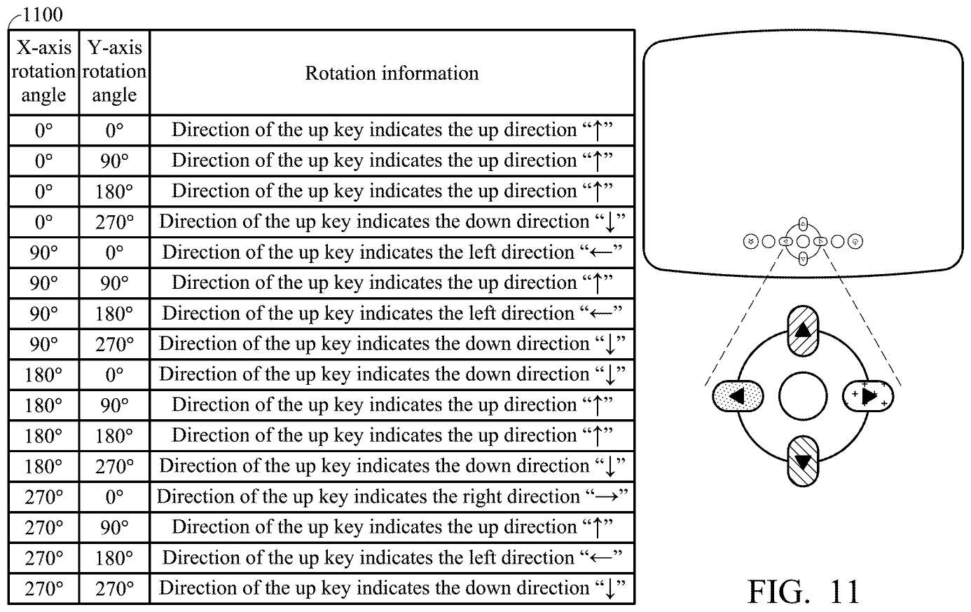

FIG. 11 is a schematic diagram illustrating a lookup table according to an embodiment of the present disclosure. In this embodiment, the lookup table 1100 can be stored in the memory of the projector. In this embodiment, the first axis of the projector is the X-axis and the second axis is the Y-axis, and the user uses the direction keys located on the upper surface of the projector. The lookup table 1100 includes a list of rotation information with the Y-axis rotation angles and the X-axis rotation angles as indices. It is assumed that the X-axis rotation angle and the Y-axis rotation angle determined by the projector are 180 degrees and 90 degrees, respectively. According to the lookup table 1100, when the X-axis rotation angle is 180 degrees and the Y-axis rotation angle is 90 degrees, the rotation information of the direction keys indicates that the direction of the up key indicates the up direction. It should be noted that although the lookup table 1100 only shows the direction of the up key, those skilled in the art can derive the rotation information of other direction keys. For example, when the X-axis rotation angle is 180 degrees and the Y-axis rotation angle is 90 degrees, the rotation information of the direction keys indicates that the direction of the right key indicates the right direction, the direction of the down key indicates the down direction, the direction of the left key indicates the left direction, and so on.

It should be noted that although the direction keys 232a, 232b, 232c and 232d are installed on the upper surface 210t and the rear 210b are used as examples in FIGS. 2A to 2C and FIGS. 8 to 11, those skilled in the art should understand that the direction keys can be installed on other sides of the device (e.g., the side or bottom, etc.) The direction settings of the direction keys installed on other sides of the device may have their corresponding lookup tables, so the details related to the direction settings of the direction keys will be omitted. Furthermore, although the projector is taken as an example in FIGS. 8 to 11, those skilled in the art can derive embodiments of other devices (for example, liquid-crystal displays) according to FIGS. 8 to 11.

As described above, the device provided in the disclosure re-defines the direction setting of the direction keys according to the first-axis and the second-axis rotation angle received by the device and the actual position of the direction keys, so as to facilitate users to operate the device at various angles without knowing the directions and provide users with better user experiences.

Having described embodiments of the present disclosure, an exemplary operating environment in which embodiments of the present disclosure may be implemented is described below. Referring to FIG. 12, an exemplary operating environment for implementing embodiments of the present disclosure is shown and generally known as an electronic device 1200. The electronic device 1200 is merely an example of a suitable computing environment and is not intended to limit the scope of use or functionality of the disclosure. Neither should the electronic device 1200 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 12, the electronic device 1200 may include a bus 1210 that is directly or indirectly coupled to the following devices: one or more memories 1212, one or more processors 1214, one or more display components 1216, one or more input/output (I/O) ports 1218, one or more input/output components 1220, and an illustrative power supply 1222. The bus 1210 may represent one or more kinds of busses (such as an address bus, data bus, or any combination thereof). Although the various blocks of FIG. 12 are shown with lines for the sake of clarity, and in reality, the boundaries of the various components are not specific. For example, the display component such as a display device may be considered an I/O component and the processor may include a memory.

The electronic device 1200 typically includes a variety of computer-readable media. The computer-readable media can be any available media that can be accessed by electronic device 1200 and includes both volatile and nonvolatile media, removable and non-removable media. By way of example, but not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 1200. The computer storage media may not comprise signal per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 1212 may include computer-storage media in the form of volatile and/or nonvolatile memory. The memory may be removable, non-removable, or a combination thereof. Exemplary hardware devices include solid-state memory, hard drives, optical-disc drives, etc. The computing device 1200 includes one or more processors that read data from various entities such as the memory 1212 or the I/O components 1220. The presentation component(s) 1216 present data indications to a user or to another device. Exemplary presentation components include a display device, speaker, printing component, vibrating component, etc.

The I/O ports 1218 allow the electronic device 1200 to be logically coupled to other devices including the I/O components 1220, some of which may be embedded. Illustrative components include a microphone, joystick, game pad, satellite dish, scanner, printer, wireless device, etc. The I/O components 1220 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, face recognition, biometric recognition, gesture recognition both on screen and adjacent to the screen, air gestures, head and eye tracking, touch recognition associated with displays on the electronic device 1200, or any combination of. The electronic device 1200 may be equipped with depth cameras, such as stereoscopic camera systems, infrared camera systems, RGB camera systems, any combination of thereof to realize gesture detection and recognition. Furthermore, the electronic device 1200 may be equipped with accelerometers, gravity sensors (G-sensors) or gyroscopes that enable detection of motion.

Furthermore, the processor 1214 in the electronic device 1200 can execute the program code in the memory 1212 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for switching a direction setting of direction keys, applied to a device, comprising:
receiving a signal, wherein the device is defined as having a first axis and a second axis, and the signal indicates a first-axis rotation angle of the device around the first axis and a second-axis rotation angle of the device around the second axis; and
switching the direction setting of the direction keys in a key area of the device according to the first-axis rotation angle and the second-axis rotation angle to perform directional control on a current display image displayed by the device.

2. The method for switching a direction setting of direction keys as claimed in claim 1, wherein the direction keys have a first direction setting, and the step of switching the direction setting of the direction keys in a key area of the device according to the first-axis rotation angle and the second-axis rotation angle further comprises:
obtaining rotation information of the direction keys according to the first-axis rotation angle and the second-axis rotation angle;
determining whether the rotation information is the same as the first direction setting; and
setting the first direction setting to a second direction setting according to the rotation information when the rotation information is different from the first direction setting, and controlling the direction of the current display image according to the second direction setting.

3. The method for switching a direction setting of direction keys as claimed in claim 2, wherein the rotation information of the direction keys is obtained from a lookup table.

4. The method for switching a direction setting of direction keys as claimed in claim 1, further comprising:
storing the direction settings;
newly receiving the signal for a predetermined period of time, and determining whether the first-axis rotation angle and the second-axis rotation angle are changed; and
switching the direction setting of the direction keys and storing the direction setting when the first-axis rotation angle and the second-axis rotation angle are changed.

5. The method for switching a direction setting of direction keys as claimed in claim 1, wherein the signal is generated by a motion sensor, wherein the motion sensor is a gyroscope, an accelerometer or a gravity sensor (G-sensor).

6. The method for switching a direction setting of direction keys as claimed in claim 1, wherein the signal is manually input by a user.

7. The method for switching a direction setting of direction keys as claimed in claim 1, wherein the device is a projector.

8. The method for switching a direction setting of direction keys as claimed in claim 7, wherein the current display image is an image projected by the projector.

9. The method for switching a direction setting of direction keys as claimed in claim 1, wherein the device is a liquid-crystal display.

10. A device for switching a direction setting of direction keys, comprising:
one or more processors; and
one or more computer storage media for storing one or more computer-readable instructions, wherein the processor is configured to drive the computer storage media to execute the following tasks:
receiving a signal, wherein the device is defined as having a first axis and a second axis, and the signal indicates a first-axis rotation angle of the device around the first axis and a second-axis rotation angle of the device around the second axis; and
switching the direction setting of the direction keys in a key area of the device according to the first-axis rotation angle and the second-axis rotation angle to perform directional control on a current display image displayed by the device.

11. The device for switching a direction setting of direction keys as claimed in claim 10, wherein the direction keys have a first direction setting, and the step of switching the direction setting of the direction keys in a key area of the device according to the first-axis rotation angle and the second-axis rotation angle performed by the processor further comprises:
obtaining rotation information of the direction keys according to the first-axis rotation angle and the second-axis rotation angle;
determining whether the rotation information is the same as the first direction setting; and
setting the first direction setting to a second direction setting according to the rotation information when the rotation information is different from the first direction setting, and controlling the direction of the current display image according to the second direction setting.

12. The device for switching a direction setting of direction keys as claimed in claim 11, wherein the rotation information of the direction keys is obtained from a lookup table.

13. The device for switching a direction setting of direction keys as claimed in claim 10, wherein the processor further executes:
storing the direction settings;
newly receiving the signal for a predetermined period of time, and determining whether the first-axis rotation angle and the second-axis rotation angle are changed; and
switching the direction setting of the direction keys and storing the direction setting when the first-axis rotation angle and the second-axis rotation angle are changed.

14. The device for switching a direction setting of direction keys as claimed in claim 10, wherein the signal is generated by a motion sensor, wherein the motion sensor is a gyroscope, an accelerometer or a gravity sensor (G-sensor).

15. The device for switching a direction setting of direction keys as claimed in claim 10, wherein the signal is manually input by a user.

16. The device for switching a direction setting of direction keys as claimed in claim 10, wherein the device is a projector.

17. The device for switching a direction setting of direction keys as claimed in claim 16, wherein the current display image is an image projected by the projector.

18. The device for switching a direction setting of direction keys as claimed in claim 10, wherein the device is a liquid-crystal display.
